(19) United States
(12) Patent Application Publication
(10) Pub. No.: US 2025/0392657 A1
(43) Pub. Date: Dec. 25, 2025

(54) PUSH TO TALK BUTTON ASSEMBLY FOR ELECTRONIC COMMUNICATION DEVICE

(71) Applicant: MOTOROLA SOLUTIONS, INC., Chicago, IL (US)

(72) Inventors: Cheah Chan Kee, Gelugor (MY); Weng Kong Hor, Butterworth (MY); Muhammad Fariz Bin Mohd Nizar, Seberang Jaya (MY); Kiam Beng Loh, Simpang Ampat (MY)

(21) Appl. No.: 18/752,695

(22) Filed: Jun. 24, 2024

(51) Int. Cl. H04M 1/02

(52) U.S. Cl. CPC H04M 1/0252; H04M 1/0206

(57) ABSTRACT

A push-to-talk button assembly for use with an electronic communications device having a housing and first switch, the button assembly includes a bezel configured to be coupled to the housing, a paddle movable with respect to the bezel and configured to engage the first switch, and a bridge. Where the bridge extends between and is coupled to both the bezel and the paddle, where the button assembly defines a longitudinal axis that passes through both the paddle and the bezel, where the bridge overlaps the bezel, where the bridge overlaps the paddle, and where the bezel, the paddle, and the bridge are all formed from a single piece of material.

### BACKGROUND

Some hand-held electronic communications devices include a “push-to-talk” button or button assembly to permit a user to selectively activate and deactivate a push-to-talk feature, which is based on communication technology that allows users to transmit audio with the push of a button or a key. It is often used in two-way radio systems to initiate audio communication between two or more parties.

### BRIEF DESCRIPTION OF THE SEVERAL VIEWS OF THE DRAWINGS

In the accompanying figures similar or the same reference numerals may be repeated to indicate corresponding or analogous elements. These figures, together with the detailed description, below are incorporated in and form part of the specification and serve to further illustrate various embodiments, examples, aspects, and features of concepts that include the claimed subject matter, and to explain various principles and advantages of those embodiments, examples, aspects, and features.

FIG. 1 is a perspective view of an electronic communication device with a push-to-talk button assembly according to one example.

FIG. 2 is a side view of the electronic communication device of FIG. 1.

FIG. 2A is the side view of FIG. 2 with the talk button assembly removed.

FIG. 2B is a section view taken along line 2B-2B of FIG. 2A.

FIG. 3 is a section view taken along line 3-3 of FIG. 2.

FIG. 4 is a detailed section view of the push-to-talk button assembly of FIG. 3.

FIG. 5 is a detailed exploded view of the push-to-talk button assembly and the electronic communication device of FIG. 1.

FIGS. 6A and 6B illustrate the installation of the push-to-talk button assembly onto the electronic communication device of FIG. 1.

FIG. 7 is a front perspective view of the first component of the push-to-talk button assembly of FIG. 1 in an installed state.

FIG. 8 is a rear perspective view of the first component of FIG. 7.

FIG. 8A is a detailed perspective view of the bridge of the first component of FIG. 7.

FIG. 9 is a front view of the first component of FIG. 7.

FIG. 10 is a side view of the first component of FIG. 7.

FIG. 11 is a section view taken along line 11-11 of FIG. 9.

FIG. 12 is the first component of FIG. 11 in an uninstalled state.

Skilled artisans will appreciate that elements in the figures are illustrated for simplicity and clarity and have not necessarily been drawn to scale. For example, the dimensions of some of the elements in the figures may be exaggerated relative to other elements to help improve understanding of the examples, aspects, and features presented in this disclosure.

The system, apparatus, and method components have been represented where appropriate by conventional symbols in the drawings, showing only those specific details that are pertinent to understanding of the various embodiments, examples, aspects, and features of the present disclosure so as not to obscure the disclosure with details that will be readily apparent to those of ordinary skill in the art having the benefit of the description herein.

### DETAILED DESCRIPTION OF THE INVENTION

As mentioned, some hand-held electronic communication devices, such as two-way radios, include a push-to-talk button assembly to permit the user to initiate audio communication between two or more parties. Activating or selecting a push-to-talk button may transition the device between an audio reception mode and an audio transmit mode. The inventors have found that the design of push-to-talk button assemblies should balance the complexity of the assembly (e.g., minimizing how many individual parts are required) with the tactile feel experienced by a user when interacting with the button assembly itself. Generally, the reduction of overall part count results in a degradation of tactility for the button assembly. Thus, there exists a need for an improved technical method, device, and system for a push-to-talk button assembly.

One example provides, a push-to-talk button assembly for an electronic communications device having a housing and first switch, the button assembly including a bezel configured to be coupled to the housing, a paddle movable with respect to the bezel and configured to engage the first switch, and a bridge extending between and coupled to both the bezel and the paddle, where the button assembly defines a longitudinal axis that passes through both the paddle and the bezel, where the bridge overlaps the bezel, where the bridge overlaps the paddle, and where the bezel, the paddle, and the bridge are all formed from a single piece of material.

Another example provides, a push-to-talk button assembly for an electronic communications device having a housing and first switch, the button assembly including a bezel configured to be coupled to the housing and defining a first reference plane, a paddle movable with respect to the bezel and defining a second reference plane, where moving the paddle relative to the bezel causes the paddle to engage the first switch, and a bridge extending between the bezel and the paddle, where the bridge includes a leg, and where the leg is offset a distance from the first reference plane to form a first gap therebetween and wherein the leg is offset from the second reference plane to form a second gap therebetween, and where the bezel, the paddle, and the bridge are all formed by a single piece of material.

Another example provides, a method of installing a push-to-talk button assembly onto an electronic communications device having a housing and a first switch, the method including molding a single piece of material including a bezel defining a first reference plane, a paddle defining a second reference plane, and a bridge extending between the bezel and the paddle, where the first reference plane forms a first angle relative to the second reference plane, and where the first angle is less than 180 degrees, providing a plunger, coupling the plunger to the housing of the electronic communications device, and coupling the single piece of material to the housing so that the bezel is fixed relative to the housing and the paddle is movable relative to the bezel, and where the paddle is engageable with the first switch via the plunger.

Each of the above-mentioned examples will be discussed in more detail below, starting with example system and device architectures of the system in which the example s may be practiced, followed by an illustration of processing blocks for achieving an improved technical method, device, and system for a push-to-talk button assembly for use on an electronic communications device.

Further advantages and features consistent with this disclosure will be set forth in the following detailed description, with reference to the figures.

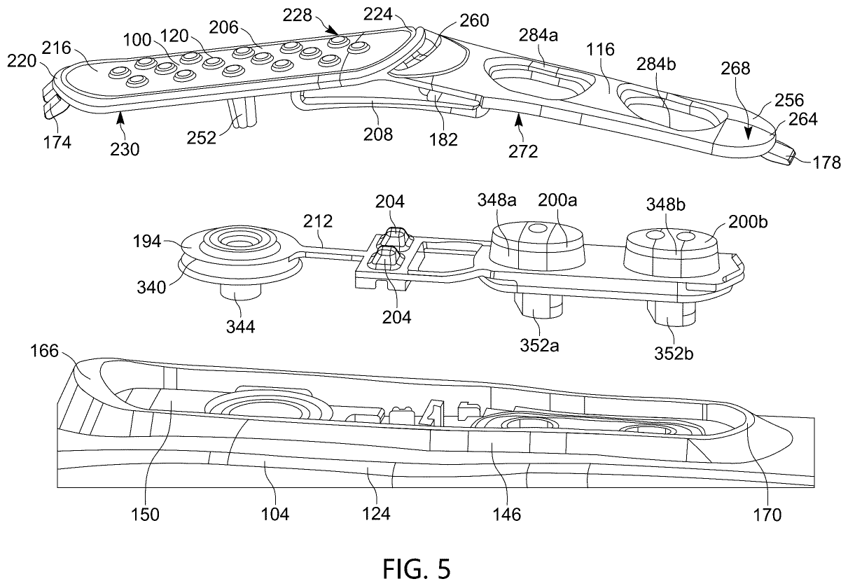

Referring now to the drawings, and in particular FIG. 5 illustrates an example of a push-to-talk button assembly 100 for use with an electronic communications device 104. In the example shown, the push-to-talk button assembly 100 includes a paddle 120. As is explained in more detail, the push-to-talk button assembly 100 exhibits a desired tactility. In addition, the architecture of the push-to-talk button assembly reduces the number of components by forming the paddle 120 as a single piece of material with the corresponding bezel 116. In the example shown, the paddle 120 is coupled to the bezel 116 via one or more cantilever bridges 208 that permit the paddle 120 and bezel 116 to be molded or otherwise formed as a single piece, but also allow sufficient relative movement between the paddle 120 and bezel 116 to assure the paddle 120 maintains a desired tactility.

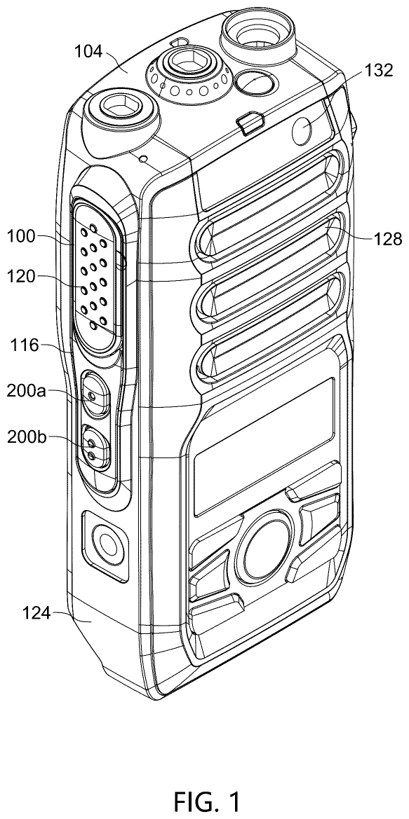

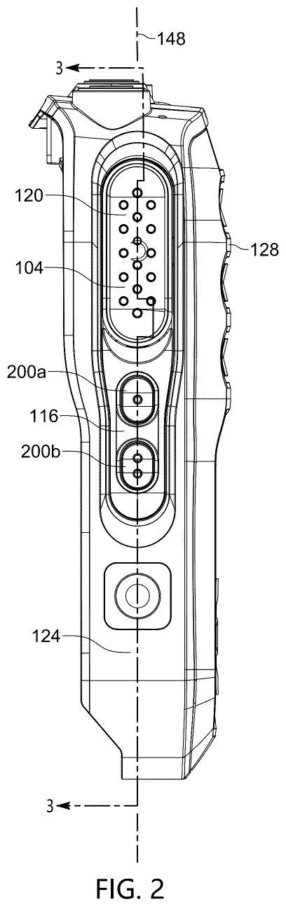

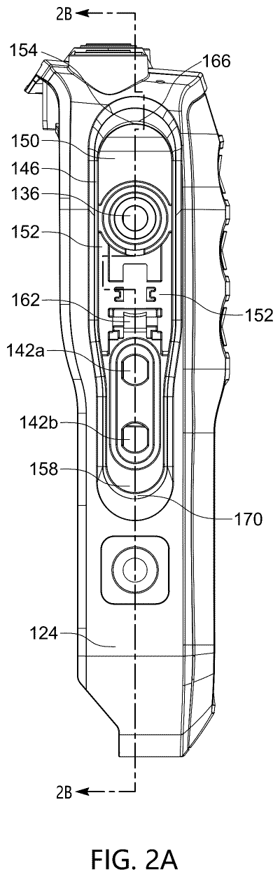

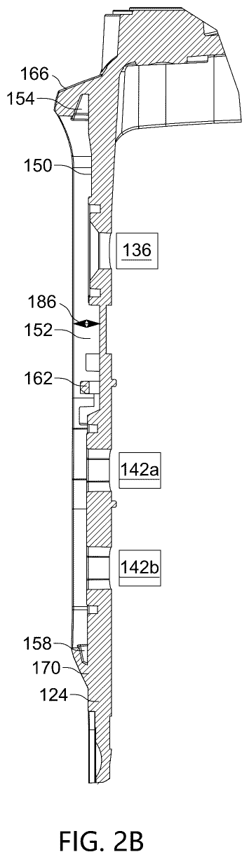

In the example shown in FIGS. 1 and 2, the electronic communications device 104 of the includes a two-way radio with a push-to-talk feature. The device 104 includes a housing 124, a speaker 128 mounted within the housing 124, a microphone 132 mounted within the housing 124, and a first switch or input 136 mounted within the housing 124 and configured to provide an input signal to the push-to-talk feature of the device 104. From a user perspective, the first switch or input 136 may be viewed as controlling the push-to-talk feature.

The first switch 136 of the device 104 is adjustable between a first or actuated configuration, and a second or unactuated configuration. When the first switch 136 is in the actuated configuration, the push-to-talk feature is activated such that the device 104 collects audio information via the microphone 132 and transmits the collected audio information at a pre-determined frequency. When so functioning, the device 104 is considered to be in a “transmit mode.” When the first switch 136 is in the unactuated configuration, the push-to-talk feature is not activated and the device 104 does not collect and transmit audio information but rather receives audio information from another device (e.g., another radio) and, for example, outputs the received audio information via the speaker 128. When so functioning, the device is considered to be in an “audio reception mode.”

While the illustrated example includes a first switch 136 to control the transition been the transmit mode and audio reception mode of the push-to-talk feature, it is understood that in other examples different forms of input may be included in the device 104 such as, but not limited to, position sensors, optical sensors, and the like. Furthermore, while the illustrated switch 136 is a two-position switch that has on and off positions, it is understood that in other examples the switch 136 may include more than one actuated configuration or be configured in other ways.

In the example shown, the device 104 also includes a second and third switch or input 142a, 142b configured to control additional features of the device 104 during use. These switches are optional. In some instances, the second and third switches 142a, 142b are both similar to the first switch 136 and adjustable between a first or actuated configuration and a second or unactuated configuration.

While the illustrated switches 142a, 142b are two-position switches, in other examples one or more of the switches 142a, 142b may be configured differently. Still further, while the illustrated example includes switches 142a, 142b, it is understood that in other examples different input mechanisms may be used.

As shown in FIG. 5, the housing 124 of the device 104 includes a mount 146 where the push-to-talk button assembly 100 may be attached to the housing 124 and interact with the first, second, and third switches 136, 142a, 142b. In one instance, the illustrated mount 146 includes a pocket 150 formed into the housing 124 that is sized and shaped to receive the combined size and shape of the paddle 120 and bezel 116 therein.

In one example, the mount 146 includes three attachment points 154, 158, 162, each configured to form a corresponding physical connection with the button assembly 100 to secure the button assembly 100 thereto. In one instance, the illustrated mount 146 includes a first attachment point 154 located proximate a first end 166 of the pocket 150, a second attachment point 158 located proximate a second end 170 of the pocket 150, and a third attachment point 162 positioned between the first attachment point 154 and the second attachment point 158. In the illustrated example, the third attachment point 162 is positioned between the first and second switches 136, 142a (see FIG. 2A).

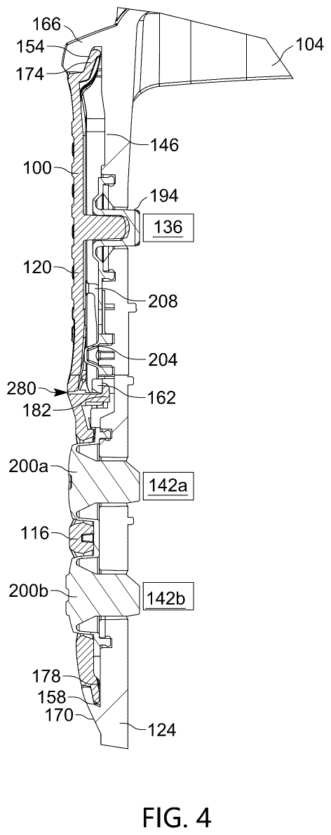

In one example, the first and second attachment points 154, 158 each include a recess formed into the housing 124 that is configured to receive a first and second mounting tab 174, 178 of the button assembly 100, respectively (see FIG. 4). The illustrated third attachment point 162 includes a pawl configured to form a snap-fit connection with a corresponding third mounting tab 182 of the button assembly 100 (discussed below). It is understood that in other examples different forms of connection may also be used at all or some of the attachment points 154, 158, 162. In addition, while the illustrated example includes three attachment points 154, 158, 162, it is understood that in other examples more or fewer attachment points may be present.

In the example shown in FIG. 2B, the pocket 150 of the illustrated mount 146 also defines a maximum pocket depth 186. The pocket 150 is sized so that the pocket depth 186 exceeds the bridge depth 190 (discussed below) of the button assembly 100. In some instances, the illustrated pocket 150 has a pocket depth 186 that exceeds the bridge depth 190 by approximately 1 mm (±1%, ±2%, ±5%, and ±10%) to provide sufficient clearance so that the bridges 208 may freely flex and move within the pocket 150 as the paddle 120 moves with respect to the bezel 116 and the housing 124. In the illustrated example, the pocket 150 of the mount 146 include a pair of grooves 152 formed into the pocket 150 to provide sufficient clearance for each of the bridges 208 to freely flex and move when the button assembly 100 is attached thereto.

In the example shown in FIG. 5, the push-to-talk button assembly 100 includes a paddle 120, a bezel 116 coupled to the paddle 120 via one or more bridges 208, a plunger 194, a first button 200a, a second button 200b, and a bumper 204. In the example shown, these elements are combined to form two individually installable components, namely, a first component 206 including the bezel 116, the paddle 120, and interconnecting bridges 208, and a second component 212 including the plunger 194, the bumpers 204, the first button 200a, and the second button 200b. The first component 206 defines a first longitudinal axis 248 that passes through both the paddle 120 and the bezel 116 (i.e., passes through the first end 220 of the paddle 120 and the second end 264 of the bezel 116, described below). During use, the user may interact with (e.g., apply and remove forces from) the paddle 120, the first button 200a, or the second button 200b to selectively actuate and de-actuate the first, second, and third switches 136, 142a, 142b, respectively.

The paddle 120 of the push-to-talk button assembly 100 is configured to serve as a first user interface to allow the user to selectively transition the device 104 between the push-to-talk transmit mode and the push-to-talk audio reception mode (described above). To enter the transmit mode, the user may apply an inward force against the paddle 120 causing the paddle 120 to move inwardly toward the housing 124, engage the first switch 136, and place the switch 136 in the actuated configuration. To leave transmit mode and return to audio reception mode, the user may remove the force applied to the paddle 120 whereby the paddle 120 will resiliently move away from the housing 124, disengage the switch 136, and allow the first switch 136 to return to the unactuated configuration.

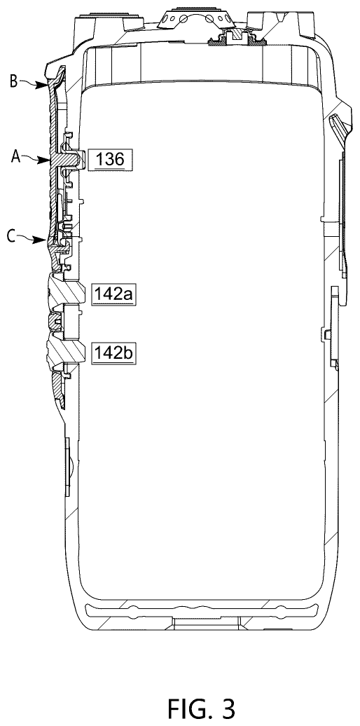

In some instances, in addition to being a two-piece design, the paddle 120 of the button assembly 100 is configured to provide a desired tactility regardless of whether the user applies the force proximate the center of the paddle 120 (i.e., force A, see FIG. 3) or applies the force proximate the edges of the paddle 120 (e.g., forces B and C, see FIG. 3). The desired tactility may be determined or expressed in terms of a tactile ratio or tact ratio. For the purposes of this application, the tact ratio (TR) is calculated as follows:

$$TR = 100 * \frac{( {F}_{TRIP} - {F}_{RELEASE} )}{{F}_{TRIP}}$$

where F_{TRIP} includes the force required to trip or actuate the first switch 136 and F_{TRIP}−F_{RELEASE} provides the physical click or tactile feedback, letting the user to know that the switch has been actuated, the bigger the number the stronger the feedback.

In some examples, the paddle 120 is configured to produce a tact ratio between 15% and 20% when measured from the geometric center of the paddle 120 (i.e., Force A). In other examples, the illustrated paddle 120 produces a tact ratio between 17% and 20%, between 18% and 20%, and between 15% and 21%. In still other examples, the illustrated button assembly 100 produces a tact ratio of approximately 20% (±1%, ±2%, ±5%, and ±10%). In still other examples, F_{TRIP} is between approximately 300 gf to approximately 500 gf.

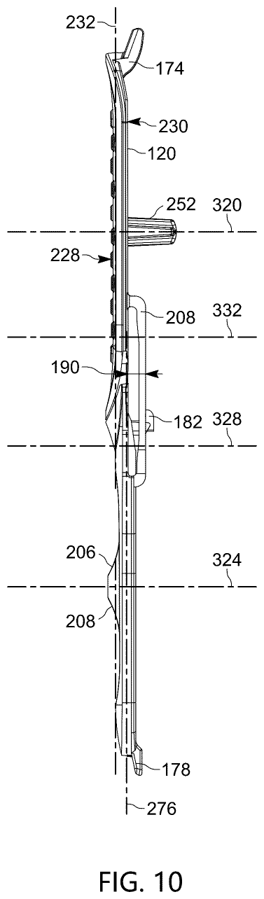

The paddle 120 includes a body 216 having a first distal end 220, and a second distal end 224 opposite the first distal end 220. The paddle 120 also defines a contact surface 228, an inner surface 230 opposite the contact surface 228, and a paddle reference plane 232 extending substantially parallel to the body 216 (see FIG. 10). When installed on the device 104, the contact surface 228 faces away from the housing 124 such that the user may selectively press or otherwise apply a force against any point on the contact surface 228 (see forces A, B, and C of FIG. 3) to move the paddle 120 with respect to the housing 124 and the bezel 116.

In one example, the paddle 120 is substantially elongated in shape having a perimeter including a pair of opposing linear sides 236 and rounded ends forming the first and second distal ends 220, 224. In addition, the surface 228 of the paddle 120 is slightly crowned or convex with a plurality of protrusions or bumps 240 extending outwardly therefrom to aid the user with tactile identification of the location of the paddle 120 and grip. While the illustrated paddle 120 includes the above-described elongated shape, it is understood that other shapes may also be used (i.e., rectangular, elliptical, polygonal, and the like). Furthermore, different contact surface 228 contours may also be used.

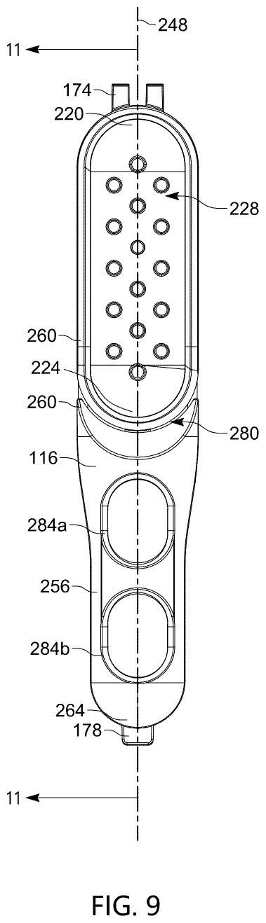

The paddle 120 also includes a first mounting tab 174 extending from the first distal end 220 and configured to form a connection with the first attachment point 154 of the mount 146. In the illustrated example, the mounting tab 174 includes a pair of protrusions extending outwardly away from the first distal end 220 parallel to the first reference axis 248 (discussed below) and angled downwardly away from the contact surface 228 (see FIGS. 9 and 10).

The paddle 120 also includes a protrusion or plunger 252 extending outwardly from the inner surface 230. In the illustrated example, the plunger 252 extends perpendicular to the first reference axis 248 (i.e., normal to the paddle reference plane 232). In some examples, the plunger 252 is positioned proximate the geometric center of the contact surface 228. During use, the plunger 252 is configured to selectively engage the first switch 136 via the plunger 194 (discussed below).

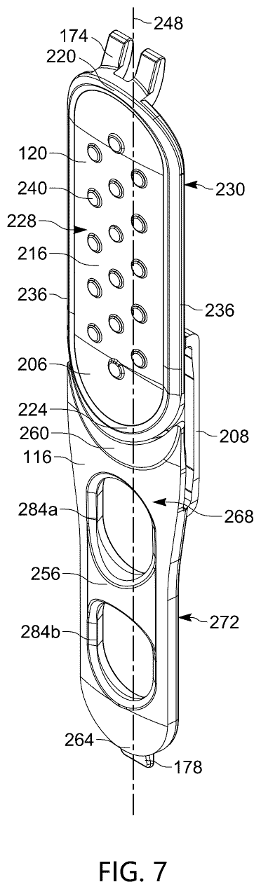

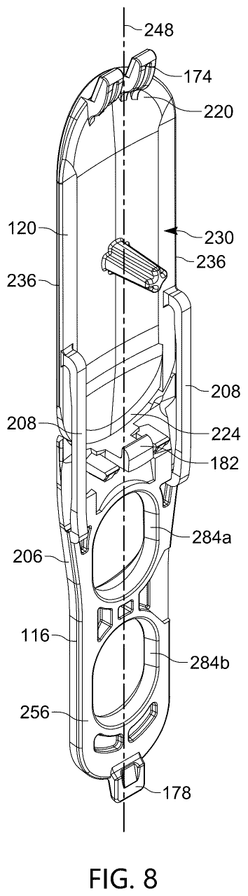

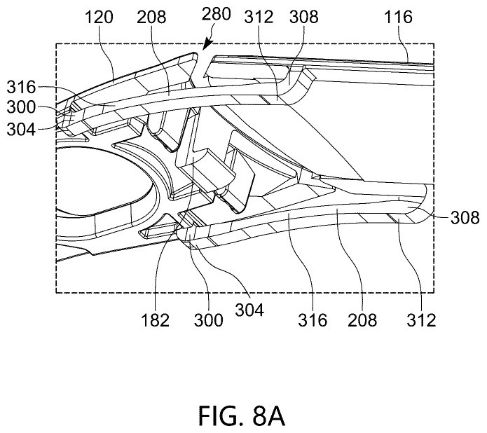

In the example shown in FIGS. 7 and 8, the bezel 116 of the push-to-talk button assembly 100 includes a body 256 having a first distal end 260, and a second distal end 264 opposite the first distal end 260. The bezel 116 also defines an outer surface 268, an inner surface 272 opposite the outer surface 268, and a bezel reference plane 276 extending substantially parallel to the body 256. Once installed on the device 104, the bezel 116 is configured to remain fixed relative to the housing 124 during use.

In the illustrated example, the bezel 116 is substantially elongated in shape having a perimeter including a rounded end forming the second distal end 264, and a concave end forming the first distal end 260. In some instances, the size and shape of the first distal end 260 generally corresponds with and mirrors the size and shape of the second distal end 224 of the paddle 120 to form a gap 280 therebetween having a gap width 356 (see FIG. 9). While the illustrated bezel 116 includes the above-described elongated shape, it is understood that other shapes may also be used (i.e., rectangular, elliptical, polygonal, and the like).

The bezel 116 also defines one or more apertures 284a, 284b each sized to allow a corresponding button 200a, 200b to extend therethrough. In the illustrated example, the bezel 116 includes two apertures 284a, 284b, however in other examples it is understood that more or fewer apertures and/or buttons may be present. In still other examples, no apertures may be present.

The bezel 116 also includes a second mounting tab 178 extending from the second distal end 264 and configured to form a connection with the second attachment point 158 of the mount 146. In the illustrated example, the second mounting tab 178 includes a single protrusion extending outwardly from the second distal end 264 parallel to the first reference axis 248 (see FIGS. 9 and 10).

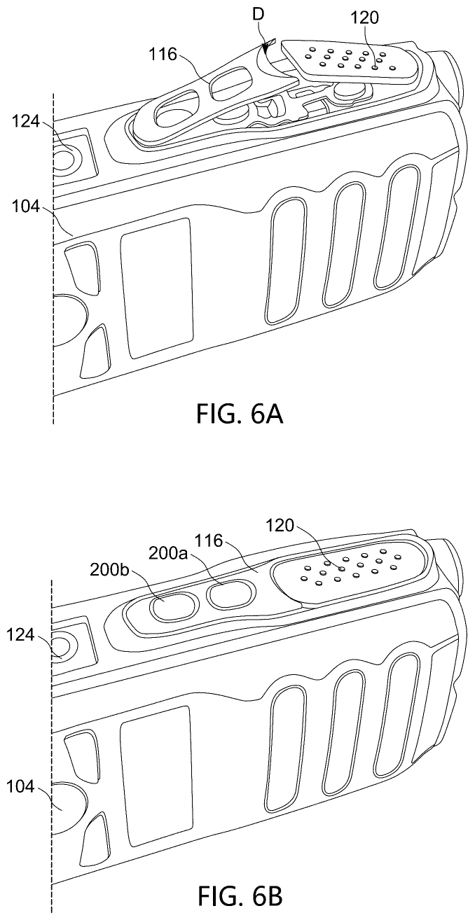

The bezel 116 also includes a third mounting tab 182 positioned proximate the first end 260 and configured to form a connection with the third attachment point 162 of the mount 146. In one example, the third mounting tab 182 is a pawl that is configured to form a snap-fit connection with the corresponding pawl of the third attachment point 162. During assembly, the application of pressure toward the housing 124 (i.e., Force D, see FIG. 6A) proximate the first end 260 causes the third mounting tab 182 to snap into engagement with and form a fixed connection with the corresponding pawl of the third attachment point 162.

As the example shown in FIG. 8A, each bridge 208 of the button assembly 100 extends between and interconnects the bezel 116 and the paddle 120 allowing for relative motion therebetween. During use, the bridges 208 are designed to be flexible so that although the paddle 120 and bezel 116 are formed from a single piece of material, they behave like two separate pieces when an external force is applied to the paddle 120 allowing the paddle 120 to freely move with respect to the bezel 116 both toward and away from the housing 124. While the illustrated example includes two bridges 208 extending between the bezel 116 and the paddle 120 (i.e., parallel to the axis 248), it is understood that in other examples more or fewer bridges 208 may be present.

In the illustrated example, each bridge 208 includes a first standoff 300 extending from the inner surface 230 of the paddle 120 to form a first distal end 304, a second standoff 308 extending from the inner surface 272 of the bezel 116 to form a second distal end 312, and a leg 316 extending between the first distal end 304 and the second distal end 312 while being spaced a non-zero distance from both the bezel 116 and the paddle 120 to form a gap with both (i.e., forming a gap with the inner surfaces 230, 272 of both the paddle 120 and bezel 116, respectively). The leg 316 of each bridge 208 is also spaced a non-zero distance from both the paddle reference plane 232 and the bezel reference plane 276 (see FIG. 10). In some examples, the leg 316 is offset from both the bezel 116 and the paddle 120 to define a bridge depth 190.

In the illustrated example, the cross-sectional shape of the leg 316 is such the leg 316 narrows in thickness as it extends away from the first and second standoffs 300, 308 so that the middle of the leg 316 is thinner than both ends proximate the standoffs 300, 308 to promote flexibility of the bridge 208 itself. In other examples, the cross-sectional shape of the leg 316 may remain constant over its entire length. In some examples, the legs 316 of each bridge may measure between 0.6 mm to 0.8 mm in thickness. In other examples, the leg 316 of each bridge 208 may vary from approximately 0.8 mm proximate the ends and approximately 0.6 mm proximate the center thereof. In still other examples, the legs 316 of each bridge 208 may average between approximately 0.6 mm to approximately 0.8 mm.

In the example shown in FIG. 10, the first standoff 300 of each bridge 208 is positioned longitudinally, relative to the axis 248, between the plunger 252 and the second end 224 of the paddle 120. In some instances, each first standoff 300 is positioned longitudinally, relative to the axis 248, so that the standoff 300 is positioned closer to the plunger 252 than to the second end 224. Stated differently, each first standoff 300 is spaced a non-zero distance from the second end 224 to form a gap therebetween. In some examples, each first standoff 300 is positioned longitudinally, relative to the axis 248, between the longitudinal midpoint 320 of the paddle 120 and the second end 224. In still other examples, each first standoff 300 is positioned longitudinally closer to the midpoint 320 than to the second end 224. In still other examples, the first standoff 300 of each bridge 208 is positioned so that it is spaced a distance inside of the perimeter of the paddle 120 (i.e., inside the perimeter of the inner surface 230).

The second standoff 308 of each bridge 208 is positioned longitudinally, relative to the axis 248, between the longitudinal midpoint 324 of the bezel 116 and the first end 260. Stated differently, each second standoff 308 is spaced a non-zero distance from the first end 260 so that there is a gap therebetween. In still other examples, the second standoff 308 of each bridge 208 is positioned so that it is spaced a distance inside of the perimeter of the bezel 116 (i.e., inside the perimeter of the inner surface 272).

In the illustrated example, the two standoffs 300, 308 are shown extending substantially the same distance from the paddle 120 and bezel 116, respectively, so that the leg 316 is substantially parallel to and offset from both the paddle reference plane 232 and the bezel reference plane 276 when the first component 206 is installed on the housing 124. However, it is understood that in other examples, the two standoffs 300, 308 may extend different distances from the paddle 120 and bezel 116 so that the leg 316 is skewed relative to one or both of the paddle reference plane 232 and the bezel reference plane 276. In still other examples, the leg 316 of each bridge 208 may be positioned so that it does not cross either the paddle reference plane 232 or the bezel reference plane 276.

As shown in FIG. 10, each bridge 208 extends between the paddle 120 and the bezel 116 such that each bridge 208 longitudinally overlaps both the paddle 120 and the bezel 116, relative to the axis 248. In some instances, each bridge 208 overlaps the bezel 116 such that a first reference plane 328 oriented normal to the first longitudinal axis 248 passes through both the bezel 116 and the bridge 208. Furthermore, each bridge 208 overlaps the paddle 120 such that a second reference plane 332 oriented normal to the first longitudinal axis 248 passes through both the paddle 120 and the bridge 208. In some examples, each bridge 208 is configured so that the first reference plane 328 passes through the bezel 116 and the leg 316 (i.e., the points where the first reference plane 328 passes through the bezel 116 and the bridge 208 are spaced apart from each other forming a gap therebetween). Furthermore, in the illustrated example, the bridge 208 is configured so that the second reference plane 332 passes through the paddle 120 and the leg 316 (i.e., the points where the second reference plane 332 passes through the paddle 120 and the bridge 208 are spaced apart from each other forming a gap therebetween).

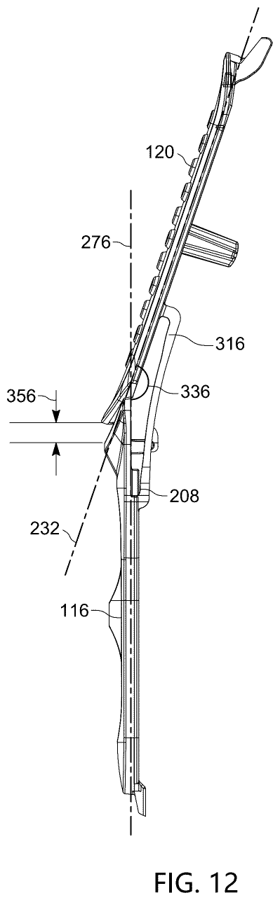

To manufacture the first component 206 of the button assembly 100, the paddle 120, bezel 116, and bridges 208 are formed together as a single piece of material. In some instances, the paddle 120, bezel 116, and bridges 208 are all molded together as a single part. In the illustrated example, the mold is shaped such that the paddle 120 is oriented at an angle with respect to the bezel 116 when the first component 206 is in an uninstalled state. As such, the paddle reference plane 232 is not parallel to the bezel reference plane 276 (see FIG. 12). In some instances, the paddle reference plane 232 forms a first angle 336 relative to the bezel reference plane 276 that is less than 180 degrees. In some examples, the first angle 336 is less than 180 degrees but greater than or equal to 90 degrees when the first component 206 is in the uninstalled state. In still other examples, the first angle 336 is approximately 165 degrees when the first component is in the uninstalled state. In still other examples, the first component 206 is between 160 and 170 degrees, and between 155 and 175 degrees when the first component is in the uninstalled state.

The resulting first component 206 is also molded so that the leg 316 of the bridges 208 forms an overall arc shape when the paddle reference plane 232 is not parallel to the bezel reference plane 276 (see FIG. 12) and is substantially linear when the paddle reference plane 232 is parallel to the bezel reference plane (see FIG. 10).

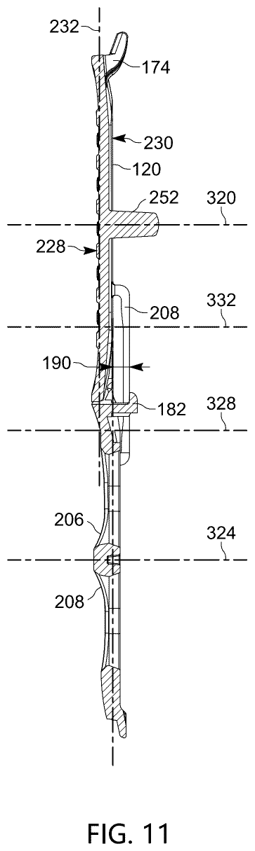

Comparing FIG. 11 with FIG. 12, the gap 280 between the paddle 120 and the bezel 116 is also influenced by the first angle 336. In some instances, the gap 280 between the paddle 120 and the bezel 116 defines a gap width 356 that changes as the first angle 226 changes. As shown in FIGS. 11 and 12, as the first angle 336 decreases the gap width 356 increases. In contrast, as the first angle 336 increases, the gap width 356 decreases. Accordingly, in some examples when the first component 206 is in the uninstalled state (i.e., the first angle 336 is less than 180 degrees), the gap width 356 is approximately 1.4 mm. In other examples, the gap width 356 is between 1 mm and 2 mm, between 1.2 mm and 1.6 mm, between 1 mm and 2.5 mm, and between 1 mm and 3 mm when the first component 206 is in an uninstalled state.

In some examples placing the first component 206 in an installed state (e.g., where the first angle 336 is approximately 180 degrees), the gap width 356 decreases to approximately 0.4 mm. In still other examples, the gap width 356 is between 0.4 mm and 1 mm when the first angle 336 is approximately 180 degrees. More generally, the gap width 356 is configured so that despite decreasing as the first angle 336 grows from an uninstalled state to an installed state, the gap width 356 remains sufficiently large to allow the paddle 120 to move relative to the bezel 116.

In the example shown in FIG. 5, the plunger 194 of the button assembly 100 is configured to convey forces between the paddle 120 and the first switch 136. In some instances, the plunger 194 is formed from an elastomeric material and includes a ring 340 configured to rest on and form a seal with the housing 124, and a sleeve 344 movable relative to the ring 340 and configured to extend through the housing 124 to engage the first switch 136 contained therein. When assembled, the plunger 252 of the paddle 120 is received within the sleeve 344 such that the sleeve 344 and paddle 120 move together as a unit with respect to the ring 340 and housing 124. In the illustrated example, the plunger 194 is formed from rubber, however in other examples the plunger 194 may be formed from silicone and/or other elastomeric materials.

As shown in FIG. 5, the button assembly 100 includes a first button 200a configured to selectively actuate the second switch 142a. In one example, the first button 200a is formed from an elastomeric material and includes a head 348a configured to extend through a corresponding aperture 284a of the bezel 116 to be accessible by the user, and a tail 352a movable together with the head 348 and configured to extend through the housing 124 to engage the second switch 142a contained therein. While the illustrated button 200a is formed from rubber, it is understood that in other examples the button 200a may be formed from other elastomeric materials such as silicone and the like.

In some instances, the button assembly 100 also includes a second button 200b configured to selectively actuate the third switch 142b. In some instances, the second button 200b is formed from an elastomeric material and includes a head 348b configured to extend through a corresponding aperture 284b of the bezel 116 to be accessible by the user, and a tail 352b movable together with the head 348b and configured to extend through the housing 124 to engage the third switch 142b contained therein. While the illustrated button 200b is formed from rubber, it is understood that in other examples the button 200b may be formed from other elastomeric materials such as silicone and the like.

In the illustrated example, the first button 200a and the second button 200b are incorporated into a single button pad. However, in other examples each button 200a, 200b may be formed individually.

In the example shown in FIG. 5, the button assembly 100 includes a pair of bumpers 204 formed from an elastomeric material and configured to be positioned between the paddle 120 and the housing 124. During use, depressing or otherwise actuating the paddle 120 (i.e., moving the paddle 120 toward the housing 124) causes the bumpers 204 to engage or otherwise contact the paddle 120 and apply a counterforce thereto. By doing so, the bumpers 204 help even out the forces experienced by the user regardless of where the forces are applied (e.g., proximate the center or proximate the edges of the contact surface 228). In the illustrated example, the bumpers 204 are positioned so that they contact the inner surface 230 of the paddle 120 off-center (e.g., displaced from the geometric center thereof). In some instances, the bumpers 204 are configured so that they engage the inner surface 230 between the second end 224 and the plunger 252. In some examples, the bumpers 204 are configured to engage the inner surface 230 between the longitudinal midpoint 320 of the paddle 120 and the second end 224.

In the illustrated example, the button assembly 100 includes a pair of frusto-pyramidal shaped bumpers 204, however it is understood that in other examples different number and shape of bumpers may be present as needed.

For assembly, the plunger 194, the first button 200a, the second button 200b, and the bumpers 204 are all formed from a single piece of elastomeric material for ease of installation. In some instances, each element 194, 200a, 200b, 204 is interconnected by a series of webbing material (see FIG. 5). The webbing material couples the elements 194, 200a, 200b, 204 together so they can be handled as a single element during the installation process and maintain the relative positions of the elements 194, 200a, 200b, 204 so they are more easily positioned within the pocket 150 of the housing 124. In other examples, all or a portion of the elements 194, 200a, 200b, 204 may be formed and installed individually.

To install the button assembly 100 onto the housing 124 of the device 104, an installer first obtains a second component 212 including the plunger 194, the bumpers 204, the first button 200a, and the second button 200b all formed from an elastomeric material (i.e., rubber) as a single unit.

With the second component 212 obtained, the installer then aligns the second component 212 with the mount 146 of the housing 124 such that the plunger 194 is aligned with the first switch 136, the first button 200a is aligned with the second switch 142a, and the second button 200b is aligned with the third switch 142b. The installer then installs the second component 212 so that the second component 212 is positioned within the pocket 150 of the mount.

With the second component 212 in place, the installer may then obtain the first component 206 in the uninstalled state. As stated above, the first component 206 in the uninstalled state is configured so that the paddle reference plane 232 is not parallel to the bezel reference plane 276 (i.e., the first angle 336 is less than 180 degrees; see FIG. 12). Furthermore, the gap width 356 is approximately 1.4 mm wide.

With the first component 206 obtained, the installer may then align the first component 206 with the mount 146 of the housing 124 such that the plunger 252 is aligned with the plunger 194, the first aperture 284a is aligned with the first button 200a, and the second aperture 284b is aligned with the second button 200b.

With the first component 206 aligned, the installer then inserts the first mounting tab 174 into the first attachment point 154 and inserts the second mounting tab 178 in the second attachment point 158 (see FIG. 6A).

After the mounting tabs 174, 178 are in place, the installer then applies a force to the first distal end 260 of the bezel 116 (see Force D of FIG. 6A). As the installer applies inward force to the first distal end 260, the first component 206 begins to flatten out such that the first angle 336 increases and the gap width 356 decreases. The heads 348a, 348b of the buttons 200a, 200b also begin to protrude through their corresponding apertures 284a, 284b of the bezel 116 and the plunger 252 is received within the sleeve 344 of the plunger 194.

The use continues to apply the inward force (Force D) until the third mounting tab 182 of the bezel 116 engages and forms a snap fit with the corresponding third attachment point 162 of the mount 146 (see FIG. 6B). With the third mounting tab 182 secured to the third attachment point 162, the bezel 116 becomes fixed relative to the housing 124.

With the button assembly 100 installed on the housing 124, the user may then begin operation of the device 104. For example, to place the device 104 in the push-to-talk “transmit mode.” The user may apply an inward force against the contact surface 228 of the paddle 120 causing the paddle 120 to move toward the housing 124 (i.e., relative to the bezel 116). As the paddle 120 moves, the plunger 252 biases the sleeve 344 of the plunger 194 inward and into engagement with the first switch 136, transitioning the first switch from the unactuated configuration to the actuated configuration. With the switch in the actuated configuration, the device 104 then enters the transmit mode.

To exit the push-to-talk “transmit mode,” the user may then remove the pressure being applied to the paddle 120 whereby the natural resilient nature of the assembly (i.e., the resiliency of the plunger 194 and the bridges 208) will bias the paddle 120 away from the housing 124. By doing so, the sleeve 344 of the plunger 194 travels together with the plunger 252 of the paddle 120 out of engagement with the first switch 136, causing the switch to transition out of the transmit mode and back into the “audio reception mode.”

In the foregoing specification, specific embodiments, examples, aspects, and features have been described. However, one of ordinary skill in the art appreciates that various modifications and changes can be made without departing from the scope of the subject matter as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has,” “having,” “includes,” “including,” “contains,” “containing,” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a,” “has . . . a,” “includes . . . a,” or “contains . . . a” does not, without more constraints, preclude the existence of additional identical elements in the process, method, article, or apparatus that comprises, has, includes, contains the element. Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

The terms “substantially,” “essentially,” “approximately,” “about,” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “one of,” without a more limiting modifier such as “only one of,” and when applied herein to two or more subsequently defined options such as “one of A and B” should be construed to mean an existence of any one of the options in the list alone (e.g., A alone or B alone) or any combination of two or more of the options in the list (e.g., A and B together).

A device or structure that is “configured” in a certain way is configured in at least that way, but may also be configured in ways that are not listed.

The terms “coupled,” “coupling,” or “connected” as used herein can have several different meanings depending on the context in which these terms are used. For example, the terms coupled, coupling, or connected can have a mechanical or electrical connotation. For example, as used herein, the terms coupled, coupling, or connected can indicate that two elements or devices are directly connected to one another or connected to one another through intermediate elements or devices via an electrical element, electrical signal or a mechanical element depending on the particular context.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples and embodiments for the purpose of streamlining the disclosure. This method of disclosure is not to be interpreted as reflecting an intention that the claimed subject matter requires more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1) A push-to-talk button assembly for an electronic communications device having a housing and first switch, the button assembly comprising:
a bezel configured to be coupled to the housing;
a paddle movable with respect to the bezel and configured to engage the first switch; and
a bridge extending between and coupled to both the bezel and the paddle, wherein the button assembly defines a longitudinal axis that passes through both the paddle and the bezel, wherein the bridge overlaps the bezel, wherein the bridge overlaps the paddle, and
wherein the bezel, the paddle, and the bridge are all formed from a single piece of material.

2) The button assembly of claim 1, further comprising a plunger configured to transmit force between the paddle and the first switch.

3) The button assembly of claim 1, further comprising a button, and wherein the bezel defines a first aperture and the button extends through the first aperture.

4) The button assembly of claim 1, wherein the paddle includes a first mounting point configured to engage the housing, and wherein the bezel includes a second mounting tab configured to engage the housing, and a third mounting tab configured to engage the housing.

5) The button assembly of claim 4, wherein at least one of the second mounting tab and the third mounting tab is configured to form a snap-fit with the housing.

6) The button assembly of claim 1, wherein the bezel defines a first reference plane, the paddle defines a second reference plane, and a portion of the bridge is offset from the first reference plane and the second reference plane.

7) The button assembly of claim 1, wherein the bridge includes:
a first standoff extending away from the bezel,
a second standoff extending away from the paddle, and
a leg extending between the first standoff and the second standoff.

8) The button assembly of claim 1, further comprising a bumper configured to extend between both the paddle and the housing.

9) The button assembly of claim 8, wherein the paddle includes a first end, a second end opposite the first end, and a midpoint equally spaced between the first end and the second end, and wherein the bumper selectively engages the paddle between the midpoint and the second end.

10) The button assembly of claim 1, wherein the bridge overlaps the bezel such that a first reference plane oriented normal to the longitudinal axis passes through both the bezel and the bridge, and wherein the bridge overlaps the paddle such that a second reference plane oriented normal to the longitudinal axis passes through both the paddle and the bridge.

11) A push-to-talk button assembly for an electronic communications device having a housing and first switch, the button assembly comprising:
a bezel configured to be coupled to the housing and defining a first reference plane;
a paddle movable with respect to the bezel and defining a second reference plane, wherein moving the paddle relative to the bezel causes the paddle to engage the first switch; and
a bridge extending between the bezel and the paddle, wherein the bridge includes a leg, and wherein the leg is offset a distance from the first reference plane to form a first gap therebetween wherein the leg is offset from the second reference plane to form a second gap therebetween, and
wherein the bezel, the paddle, and the bridge are all formed by a single piece of material.

12) The button assembly of claim 11, wherein the bridge includes:
a first standoff extending away from the bezel,
a second standoff extending away from the paddle, and
wherein the leg extends between the first standoff and the second standoff.

13) The button assembly of claim 12, wherein the paddle defines a contact surface configured to face away from the housing when the paddle is coupled thereto, wherein the paddle defines an inner surface opposite the contact surface, and wherein the second standoff extends from the inner surface of the paddle.

14) The button assembly of claim 12, wherein the paddle includes a perimeter, and wherein the first standoff is spaced a distance from the perimeter to form a gap therebetween.

15) The button assembly of claim 11, wherein the bezel is configured to be fixedly coupled to the housing.

16) A method of installing a push-to-talk button assembly onto an electronic communications device having a housing and a first switch, the method comprising:
molding a single piece of material including a bezel defining a first reference plane, a paddle defining a second reference plane, and a bridge extending between the bezel and the paddle, wherein the first reference plane forms a first angle relative to the second reference plane, and wherein the first angle is less than 180 degrees;
providing a plunger;
coupling the plunger to the housing of the electronic communications device; and
coupling the single piece of material to the housing so that the bezel is fixed relative to the housing and the paddle is movable relative to the bezel, and wherein the paddle is engageable with the first switch via the plunger.

17) The method of claim 16, wherein coupling the single piece of material to the housing causes the first angle to increase.

18) The method of claim 17, wherein coupling the single piece of material to the housing causes the first angle to increase to 180 degrees.

19) The method of claim 17, wherein the single piece of material includes a gap between the paddle and the bezel defining a gap width, and wherein increasing the first angle causes the gap width to decrease.

20) The method of claim 16, wherein the single piece of material includes a first end formed by the paddle and a second end formed by the bezel, wherein the single piece of material includes a first mounting tab extending from the first end, a second mounting tab extending from the second end, and a third mounting tab positioned between the first mounting tab and the second mounting tab, and wherein coupling the single piece of material to the housing includes coupling the first mounting tab and the second mounting tab to the housing and subsequently coupling the third mounting tab to the housing via a snap-fit.
